(19) United States
(12) Patent Application Publication
(10) Pub. No.: US 2019/0100956 A1
(43) Pub. Date: Apr. 4, 2019

(54) EDGE PIECE AND WINDOW-EDGE PIECE COMPOSITE

(71) Applicant: Knauf Gips KG, Iphofen (DE)

(72) Inventor: Thomas Wieczorek, Mainbernheim (DE)

(21) Appl. No.: 16/082,688

(22) PCT Filed: Mar. 14, 2017
(86) PCT No.: PCT/EP2017/000331

§ 371 Date: Sep. 6, 2018

(30) Foreign Application Priority Data
Mar. 15, 2016 (DE) 102016003110.7

(51) Int. Cl. E06B 1/70; E06B 7/14

(52) U.S. Cl. CPC E06B 1/702; E06B 2001/707; E06B 7/14

(57) ABSTRACT

The invention relates to an edge piece for a connection impermeable to driving rain in the region of window sill, window and facade. The edge piece has coupling elements which form a positive connection with complementary coupling elements of a window frame.

The invention relates to an edge piece and a window-edge piece composite.

At the interface of the facade to windows or house doors, three different trades are represented. Along with the window fitter and the window sill fitter, painters/plasterers also work at this position. As a result of lack of communication on building sites, of non-optimized site practices or lack of technical knowledge, serious processing errors frequently occur with this planning detail which have the result that component connections do not meet their technical requirements, especially the requirement for impermeability to driving rain.

Leaks occur through which water enters into the facade under conditions of driving rain and this can result in damage to the building, particularly to the heat insulation and the plaster system applied to this. Experience shows that the monolithic design effectively copes with penetrating water, however, major damage can be found with continuously increasing wood construction. Penetrating water can so massively impair the basic wood frame structure that there is a risk that the load-bearing capacity of the structure will be reduced.

The construction materials used in wood construction are frequently moisture-sensitive. Glass wool as cavity insulation or impregnated plasterboard fire protection boards as support boards for heat-insulation composite systems on the exterior are just as moisture-sensitive as wood fibre insulating boards which are installed as full-heat insulation and also function as plaster carriers. Along with swelling of the last-described building material, discolorations on the plaster facade are a frequent indicator for penetrated moisture. While this is only a visual defect, in the worst case the swelling of the board results in bursting of the plaster and consequently in considerable damage to the facade.

According to the present prior art, incident driving rain is drained on the one hand via plastering strips on the window and on the other hand via window sills, the so-called first water-guiding plane. In component tests for precisely this component, these systems by themselves alone can usually demonstrate impermeability to driving rain. In the installed state however, this property is frequently no longer given since leaks occur at interfaces, inter alia the so-called trade hole. The interface in the lower corner region between window or sun protection guide rail, window sill and facade reveal is defined as the trade hole.

Second water-guiding planes, of which there are some on the market, should solve this problem. However, these products frequently do not fulfil their task or can hardly be implemented technically or only with great difficulty. An example for this is a system which provides a “closed trough” (=second water-guiding plane) but does not intercept/drain the incoming water. Consequently this system is largely functionless.

Another disadvantage is that many system producers specifically formulate the aim for their product, namely a three-sided trough as a second water-guiding plane but do not give any precise information for this procedure as to how this is to be achieved. The processor on site is left alone with this problem. Defective processing and resulting damage are the consequence.

The object of the invention is to provide a facade and/or window sill connection which forms the basis for a functioning second water-guiding plane and the associated controlled draining of penetrated moisture.

The object is solved by an edge piece according to claim 1 and a window-edge piece composite according to claim 10. Advantageous further developments of the invention are specified in the subclaims.

An edge piece according to the invention is characterized in that the edge piece comprises one or more coupling elements which can be connected positively to one or more coupling elements of a window frame. For simplicity the term window is merely used subsequently. However, the embodiments which comprise a door instead of a window should also be meant by this term.

The coupling elements can, for example, comprise elements of a tongue-and-groove connection or a latching connection. Edge pieces form the termination of a window sill and make the connection to the facade. They serve as a support for the facade insulation and at the same time enable an over-insulation of the window frame of 0.3 cm, which is prescribed in accordance with DIN 4108-02.

Window frames for windows or doors are frequently extruded as endless profiles, They have hollow chambers for heat insulation and profilings for connection to further profile parts. These endless profiles are mitred by the window manufacturers and corresponding window or door frames are made up from the individual parts. Thus, many window or door frames have profilings on their underside which have no function at this point but form a passage point for driving rain. The profilings can advantageously be used by fitting an edge piece with a complementary profiling. The edge piece fitted with the complementary profiling can then be clicked positively onto the window frame or inserted into the window frame during window or door installation and thus closes the entry point for driving rain in the area of the trade hole.

According to a preferred further development of the invention, an outer side of the edge piece to be arranged on the window side is adapted to be connected in a flat water-tight manner to a window mounting profile. Particularly advantageously this outer side has a geometry complementary to the contact surface of the window frame so that a tight positive fit is also possible here. Particularly preferably, the coupling elements and also the remaining connection between edge piece and window frame can be additionally sealed, for example, by means of a watertight adhesive bonding and/or an additional screw connection.

A further embodiment of the invention provides that the edge piece comprises at least one upper side, a lower side, a side part and a rear side, wherein the lower side is wider than the upper side. The widened lower side serves as a rest for a window parapet or a wedge plate. Furthermore, the widened lower side allows a watertight connection to an additional sealing film in the area of the window parapet or the wedge plate in a simple manner.

It is also advantageous if the rear side of the edge piece, i.e. the side to be arranged on the window side, has a greater width than the upper side. The rear side is preferably precisely as wide as a width of the lower side. This configuration also enables a problem-free watertight connection to a second water-guiding plane in the contact area on the window frame of the window, which for example can be formed by a sealing film. Furthermore, it seals the contact area between window frame, edge piece and window parapet.

The window elements are preferably arranged on the upper side of the edge piece. Thus, the edge piece can be attached in a simple manner from below to the corresponding location of the window frame and closes the entry path for driving rain in the lower area of the window frame.

A particularly preferred embodiment of the invention provides that the edge piece is adapted to receive insulating material, in particular an insulating core. To this end the edge piece can be hollow so that a corresponding insulating core can be inserted. The edge piece can already be fitted with the insulating core at the factory. However, it is also possible to prepare the edge piece merely for this use so that the insulating core is inserted at the building site. This embodiment advantageously also enables the over-insulation of the window frame at this point, which is prescribed according to DIN 4108-02.

Preferably the edge piece has a bent region in the longitudinal section so that the lower side of the edge piece deviates from a straight line at an obtuse angle with an angular deviation of at least 40, preferably about 50. In this way, the longitudinal extension of the edge piece can be adapted to the descending geometry of the window sill towards the drip nose.

The edge piece can consist of any suitable materials. It is possible to form the edge piece similarly to many plastic window frames as a moulding made of polyvinyl chloride (PVC). Such a moulding can, for example, by produced by injection moulding. However, neither the method of manufacture nor the material used should be restricted by this information.

A window-edge piece composite according to the invention is characterized in that an edge piece is connected positively to one or more coupling elements of a window frame of a window by means of one or more coupling elements. The coupling elements can, for example, comprise elements of a tongue-and-groove connection or a latching connection. With such a connection, the trade hole can be simply and reliably closed without particular craftsmanship being required.

It is particularly advantageous if a window-side geometry of the edge piece is adapted positively to a geometry of the window frame so that the connection between the edge piece and the window frame, possibly with the aid of further sealing means, is watertight.

If sealing means are used, these can, for example, comprise watertight adhesives or sealing compounds.

In order to obtain a complete second water-guiding plane, the window-edge piece composite can additionally comprise a sealing film which is arranged so that it forms together with the edge piece a trough open to a facade side. Two edge pieces, arranged as a window sill connection on the right and left of the window sill, can for example be connected to a sealing film web which is bent up on the window side. A trough is formed which drains water penetrating under the window sill towards the facade. The trade holes are reliably closed by the edge pieces.

The edge piece is advantageously one of the above-described embodiments.

The invention is described in detail hereinafter with reference to drawings of an exemplary embodiment. In the figures:

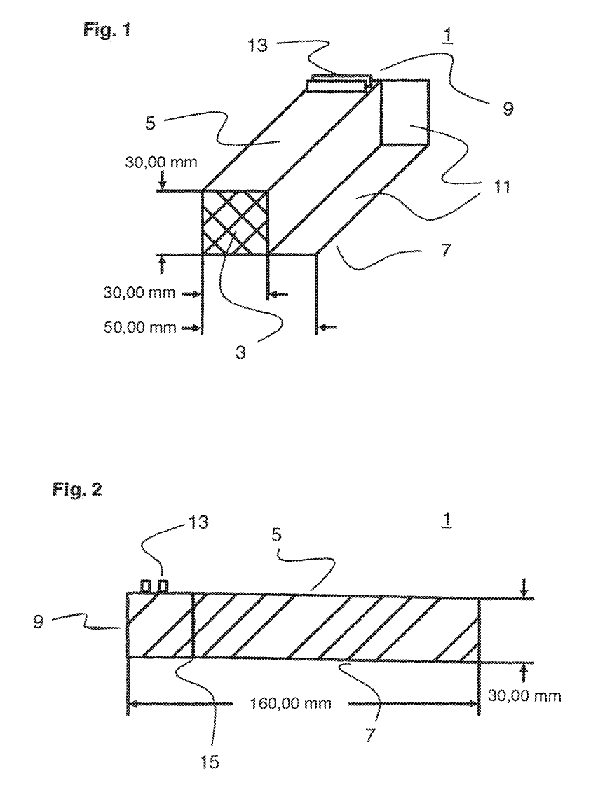

FIG. 1: shows a schematic drawing of an edge piece according to the invention,

FIG. 2: shows a lateral sectional view of the edge piece according to FIG. 1,

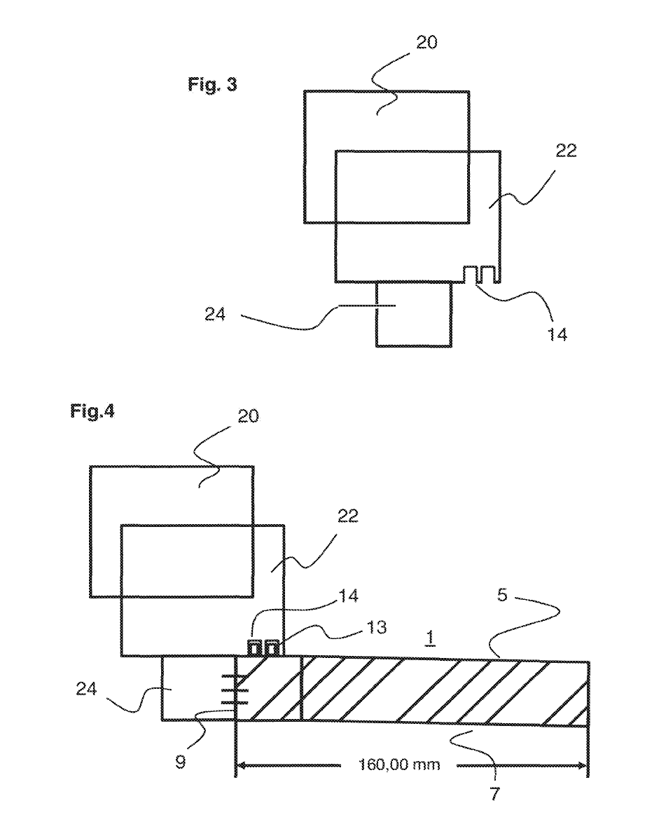

FIG. 3: shows a lateral sectional view through a casement, a window frame and a mounting profile of a window,

FIG. 4: shows a window-edge piece composite in sectional view.

FIG. 1 shows a schematic view of an edge piece 1 according to the invention. The edge piece 1 consists of an injection-moulded or extruded material, for example, of PVC. The exemplary embodiment shown here is fundamentally rectangular but has no closed lateral surface. The interior of the edge piece is hollow and is filled with an insulating core 3, for example, made of extruded polystyrene foam.

The upper side 5 of the edge piece is narrower than its lower side 7 and its rear side 9 so that in each case an overhang 11 is formed. This overhang 11 can be used for adhesive bonding to a sealing film to produce a second water-guiding plane.

Located on the upper side 5 of the edge piece 1 on its window-side end are, for example, two coupling elements 13 which are connected to the profiling of a window frame during insertion. The closure of the profiling of the window frame by the coupling elements 13 of the edge piece is watertight; the connection is positive.

FIG. 2 shows a lateral sectional view of the edge piece 1 according to FIG. 1. The lower side 7 of the edge piece has a bend 15 which is greater than 4°, preferably about 5°. The bend 15 in the lower side 7 adapts the edge piece to the geometry of the substructure of the window sill. A gradient towards the outer side of the facade is adjusted by means of a wedge plate so that incoming rain water s drained towards the outside.

The bend region 15 is arranged so that it does not begin underneath the window frame when the edge piece is installed so that a stable and positive connection to the base can be made.

FIG. 3 shows a lateral sectional view through a casement 20, a window frame 22 and a mounting profile 24 of a window. The profiling 14 of the underside of the window frame is shown schematically. It has a geometry complementary to the coupling elements 13 of the edge piece. The profiling 14 is not used otherwise in the lower area of the window and forms an entry point for rain water.

FIG. 4 shows an exemplary embodiment of a window-edge piece composite in a sectional view. The coupling elements 13 of the edge piece 1 are clicked into or inserted into the complementary coupling elements 14 of the window frame. The rear side 9 of the edge piece is connected by means of MS polymer sealing materials or silicone-based sealing materials to the outer side of the mounting profile in a watertight manner. The geometries of the rear side 9 of the edge piece and the front side of the mounting profile are matched to one another so that a positive connection is obtained. The edge piece 1 can be over-insulated upwards according to DIN 4108-02. The upper side of the edge piece 5 serves as contact surface for the insulation.

1. An edge piece comprising:
one or more coupling elements which can be connected positively to one or more coupling elements of a window frame.

2. The edge piece according to claim 1, wherein the coupling elements are elements of a tongue-and-groove connection or a latching connection.

3. The edge piece according to claim 1, wherein an outer side of the edge piece to be arranged on the window side is configured to be connected in a flat water-tight manner to a window mounting profile.

4. The edge piece according to claim 1, wherein the edge piece comprises at least one upper side, a lower side, a side part and a rear side, and wherein the lower side is wider than the upper side.

5. The edge piece according to claim 4, wherein the rear side has a greater width than the upper side.

6. The edge piece according to claim 1, wherein the coupling elements are arranged on the upper side of the edge piece.

7. The edge piece according to claim 1, wherein the edge piece is configured to receive insulating material.

8. The edge piece according to claim 1, wherein the edge piece has a bent region in the longitudinal section so that the lower side of the edge piece deviates from a straight line at an obtuse angle with an angular deviation of at least 4°.

9. The edge piece according to claim 1, wherein the edge piece comprises PVC.

10. A window-edge piece composite, comprising:
an edge piece that is connected positively to one or more coupling elements of a window frame of a window with one or more coupling elements.

11. The window-edge piece composite according to claim 10, wherein the coupling elements comprise elements of a tongue-and-groove connection or a latching connection.

12. The window-edge piece composite according to claim 10, wherein a window-side geometry of the edge piece is configured positively to a geometry of the window frame so that the connection between the edge piece and the window frame, optionally with the aid of further sealing means, is watertight.

13. The window-edge piece composite according to claim 12, wherein the sealing means comprise watertight adhesives or sealing compounds.

14. The window-edge piece composite according to claim 10, wherein the composite additionally comprises a sealing film which is arranged so that it forms together with the edge piece a trough open to a facade side.

15. The window-edge piece composite according to claim 10, wherein the edge piece comprises at least one upper side, a lower side, a side part and a rear side, and wherein the lower side is wider than the upper side.

16. The edge piece according to claim 3, wherein the outer side of the edge piece to be arranged on the window side is configured to be adhesively bonded in a flat water-tight manner to the window mounting profile.

17. The edge piece according to claim 5, wherein the width of the rear side is as wide as the width of the lower side.

18. The edge piece according to claim 7, wherein the insulating material is an insulating core.

19. The edge piece according to claim 8, wherein the lower side of the edge piece deviates from the straight line with the angular deviation of about 5°.

20. The edge piece according to claim 9, wherein the edge piece is a PVC moulding.
